(19) United States
(12) Patent Application Publication
(10) Pub. No.: US 2008/0120414 A1
(43) Pub. Date: May 22, 2008

(54) Representing resource constrained devices in a network

(76) Inventors: Nandakishore Kushalnagar, Portland, OR (US); Chris Gough, Portland, OR (US)

Correspondence Address: INTEL/BLAKELY, 1279 OAKMEAD PARKWAY, SUNNYVALE, CA, 94085-4040, US

(21) Appl. No.: 11/601,102

(22) Filed: Nov. 17, 2006

(51) Int. Cl. G06F 15/173

(52) U.S. Cl. 709/226

(57) ABSTRACT

An access point to enhance the representation of the resource constrained devices in a network. The resource constrained devices may be coupled to a short-range network and may wake up from sleep mode only in pre-specified time durations. The access point may create proxy device for each identified resource constrained device. The access point may generate resultant values based on the data values generated by the resource constrained devices and the service values, which comprise additional information such as time-stamp. The access point may provide the resultant values to the devices coupled to the medium and/or high-range network even while the resource constrained devices are in sleep mode.

### BACKGROUND

Resource constrained devices generally refer to devices with low memory and low processing capabilities, relative to the cutting edge technology. Such devices may operate at low power as well. For example, health care, home automation, and industrial automation environments may comprise resource constrained devices such as glucometers, motion sensors, and vibration sensors.

The resource constrained devices may wake up from ‘sleep mode’ and enter ‘active mode’, only, during pre-specified time intervals.

The resource constrained devices may generate data values that may, for example, represent measurement of physical variables such as blood pressure, vibration, motion, and temperature while operating in active mode. For example, the vibration sensor may enter ‘active mode’ in a pre-specified time interval and generate data values which may represent measurement of vibration.

The services provided by the resource constrained devices may be inadequate due to limited resources. However, increasing the resources on the resource constrained devices may increase the cost and complexity of the resource constrained devices. The vibration sensors, for example, may not comprise a clock to time stamp the data values. As a result the resource constrained devices may be inadequately represented, for example, in a computer network environment.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of an environment comprising resource constrained devices.

FIG. 2 illustrates an embodiment of an access point of the network environment of FIG. 1.

FIG. 3 illustrates an embodiment of the access point, which enhances representation of the resource constrained devices in a network.

FIG. 4 illustrates an embodiment of the access point, which enables enhanced control of the resource constrained devices.

FIG. 5 depicts a sequence diagram, which illustrates the access point performing device description and discovery to enhance the representation of resource constrained devices in a network.

FIG. 6 depicts a sequence diagram, which illustrates the access point performing device control and eventing to enhance the representation of resource constrained devices in a network.

### DETAILED DESCRIPTION

The following description describes representing resource constrained devices in a network. In the following description, numerous specific details such as logic implementations, resource partitioning, sharing, and duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device).

For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

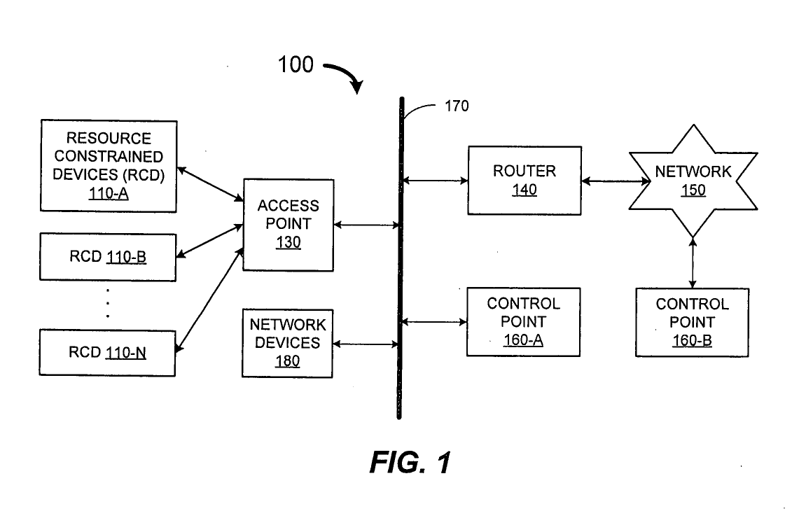

An embodiment of an environment 100 is illustrated in FIG. 1. The environment 100 may comprise resource constrained devices 110-A to 110-N, an access point 130, a router 140, a network 150, control points 160-A and 160-B, a local area network (LAN) 170, and network devices 180.

In one embodiment, the resource constrained devices 110 may couple to the access point 130 via a first network such as a low-power and a low-range network. In one embodiment, the router 140, the network 150, the control point 160, the LAN 170, and the network devices 180, together, may form a second network, which may represent a medium or high-range network.

The resource constrained devices 110 may generate one or more data values based on the measurement of physical variables and may send the data values to the access point 130. In one embodiment, the resource constrained devices 110 may send initialization signals to the access point 130 after being switched ON. In one embodiment, the resource constrained devices 110 may enter ‘active mode’ at pre-specified time points and would be in ‘sleep mode’ otherwise.

In the active mode, the resource constrained devices 110 may generate one or more data values, which may represent measurement of variables such as pressure, temperature, vibration, and motion. In one embodiment, the resource constrained devices 110 may send the data values to the access point 130 through the first network. In one embodiment, the resource constrained devices 110 may couple to the access point 130 using the first network, which may be provisioned based on communication technologies such as BlueTooth®, ZigBee®, USB®, and Z-Wave.

The resource constrained devices 110-A through 110-N may represent, for example, transducers and sensors such as vibration sensors, blood-pressure monitoring cuffs, and motion sensors, which comprise limited processing and memory resources. In one embodiment, the resource constrained devices 110 may comprise low memory, low processing capabilities, and may operate at low power levels as well. As a result, the resource constrained devices 110 may not be capable of storing, processing, and providing additional services such as generating statistics and time-stamping the data values.

The access point 130 may enhance the representation of the resource constrained devices 110 in the second network. In one embodiment, the access point 130 may enhance the range of the resource constrained devices 110 by adequately representing the resource constrained devices 110. In one embodiment, the access point 130 may enhance the representation of the resource constrained devices 110 by serving as a proxy device to the resource constrained devices 110.

In one embodiment, the access point 130 may create a proxy device for each of the identified resource constrained device 110-A to 110-N. In one embodiment, due to creation of proxy devices, the access point 130 may serve as a point of contact for the control points 160. The access point 130 may thus hide the resource constrained devices 110 from being directly accessed by the control points 160 or any other device coupled to the LAN 170 and the network 150.

In one embodiment, the access point 130 may generate a resultant value based on the data value received from, for example, the resource constrained device 110-A and an appropriate service value generated by the access point 130. In one embodiment, the access point 130 may, frequently, provide broadcasts and services even while the resource constrained devices 110 are in the ‘sleep mode’.

In one embodiment, the access point 130 may provide interoperability between the resource constrained devices 110 and the control point 160 comprising computing platforms such as a personal computer, personal health system, cell phone, and such other devices. Such an approach may enhance the representation of the resource constrained devices 110 in the second network comprising the LAN 170 and the network 150.

In one embodiment, the access point 130 may support communication standards such as BlueTooth®, Z-Wave, ZigBee®, and USB® to enable the resource constrained devices 110 to couple to the access point 130. The access point 130 may, also, support communication standards such as IEEE standard 802.11™ and TCP/IP, which enable the access point 130 to couple to the devices, such as the router 140, network devices 180, and the control point 160-A and 160-B.

In one embodiment, a second device such as the control point 160-A coupled to the LAN 170 and 160-B coupled to the network 150 may generate control signals based on the resultant values. The control points 160-A and 160-B may control the operation of the network devices 180 based on the resultant values. In one embodiment, the control points 160-A and 160-B may represent a computer system comprising Intel® Pentium® microprocessors: In one embodiment, the control points 160-A and 160-B may support communication standards such as IEEE standard 802.11™ and TCP/IP, which enable the control points 160-A and 160-B to couple to the LAN 170 or to the network 150.

In one embodiment, the control point 160-B may send a request to receive, for example, the data values generated by the resource constrained device 110-N. The control point 160-B may send such a request to the access point 130 via the network 150 and the router 140. The control point 160-B may receive a response comprising the resultant values and generate control signals based on the resultant values, which may be used to control the network devices 180.

The network devices 180 may comprise devices such as a television, printer, media servers, web-servers, data-base servers, Wi-Fi access devices, final control elements, and gateways. In one embodiment, the network devices 180 may operate based on the control signals generated by the control points 160. In one embodiment, the network devices 180 may be coupled to the LAN 170 using Ethernet, Wi-Fi, and other similar technologies. Such network devices may also be coupled to the network 150.

The router 140 may enable transfer of data units between the various devices coupled to the LAN 170 and the network 150. In one embodiment, the router 140 may forward a request to the access point 130 that is received from the control point 160-B. The router 140 may receive a response from the access point 130 and send the response to the control point 160-B. Also, the router 140 may route the control signals from the control point 160-B to the network devices 180. The router 140 may, also, send requests of the control point 160-A to an access point that may be coupled to the network 150. The router 140 may route the requests and responses to the devices coupled to the LAN 170 and the network 150 based on routing table entries. In one embodiment, the router 140 may support communication standards such as IEEE standard 802.11™ and TCP/IP, which enable the router 140 to couple to the LAN 170 and the network 150.

The network 150 may comprise one or more intermediate devices such as switches and routers, which may receive, process, and send the request and responses to an appropriate network device. The network 150 may enable communication between various devices coupled to the LAN 170 and the network 150. The intermediate devices of the network 150 may be configured to support various protocols such as TCP/IP.

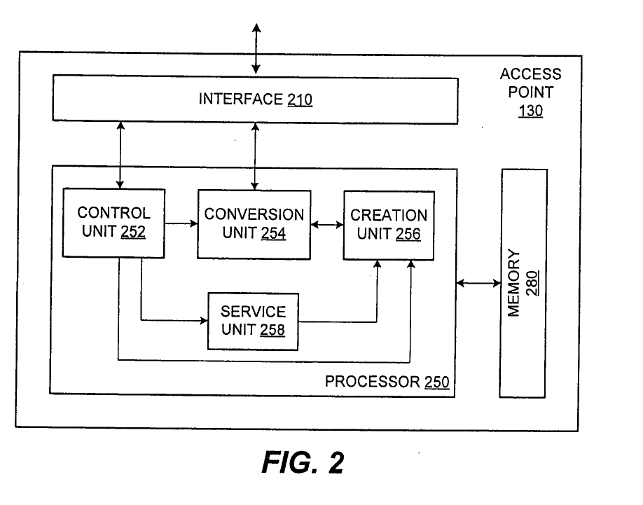

An embodiment of the access point 130 is illustrated in FIG. 2. In one embodiment, the access point 130 may comprise an interface 210, processor 250, and a memory 280. In one embodiment, the components of the access device 130, which enhance the representation of the resource constrained devices 110, may be integrated with other devices such as the router 140.

The interface 210 may receive data values from the resource constrained devices 110 and pass the data values to the processor 250. The interface 210 may receive request packets from the control point 160-A and/or 160-B and may pass the request packets to the processor 250. In one embodiment, the interface 210 may send responses, generated by the processor 250, to the control points 160-A and 160-B. In one embodiment, the interface 210 may support communication standards such as BlueTooth®, ZigBee®, and USB® and IEEE standard 802.11™ and TCP/IP. The interface 210 may provide physical, electrical, and protocol interfaces to transfer requests, responses, and data values between the access point 130 and the other devices of the environment 100.

The memory 280 may store the resultant values, data values received from each resource constrained devices 110, and the service values, which may be used by the processor 250 to process the requests. In one embodiment, the memory 280 may store the resultant values associated with a corresponding proxy device. In one embodiment, the memory 280 may comprise a dynamic random access memory (DRAM) and a static random access memory (SRAM).

The processor 250 may enhance the representation of the resource constrained devices 110 in a network environment such as the environment 100. In one embodiment, the processor 250 may comprise a control unit 252, a conversion unit 254, a creation unit 256, and a service unit 258. In one embodiment, the processor 250 may perform tasks such as device description and discovery and controlling to enhance the representation of the resource constrained devices 110.

In one embodiment, the control unit 252 may identify the resource constrained devices 110 based on the initialization signals received the resource constrained devices 110. In one embodiment, the control unit 252 may generate a create signal, which may be sent to the creation unit 256. In one embodiment, the control unit 252 may generate a first create signal based on the initialization signal received from a first resource constrained device 110-N. In one embodiment, in response to the access point 130 receiving a first data value, the control unit 252 may generate control signals, which may be sent to the conversion unit 254, the creation unit 256, and the service unit 258.

In one embodiment, the control unit 252 may send device advertisements, which may comprise a list of the proxy devices. The control unit 252 may receive device search queries and may generate a description of the proxy devices, which correspond to the search query. In one embodiment, the control unit 252 may retrieve data from the memory 280 to generate, for example, status update of the resource constrained devices 110.

The conversion unit 254 may receive data units from a first unit, perform protocol conversion, and send the data units to a second unit. In one embodiment, the conversion unit 254 may receive the first data unit from the interface 210, extract the first data value, and send the first data value to the creation unit 256. For example, the conversion unit 254 may receive the first data unit in a BlueTooth® protocol format. The conversion unit 254 may receive the first resultant value from the creation unit 256 and generate a first response unit, which may be in TCP/IP protocol format. The conversion unit 254 may forward the first response unit to the interface 210. The conversion unit 254 may operate under the control of the control unit 252.

In one embodiment, the creation unit 256 may create a proxy device for each identified resource constrained device 110 based on the create signal received from the control unit 252. In one embodiment, the creation unit 256 may generate a first proxy device based on the first create signal. In one embodiment, the creation unit 256 may generate a first resultant value based on the first data value, received from the conversion unit 254, and a first service value, received from the service unit 258. In one embodiment, the creation unit 256 may send the first resultant value to the conversion unit 254.

For example, the first data value may equal a number, which may represent measurement of blood pressure and a first service value may, also, equal a number, which may represent a time-stamp. In one embodiment, the time-stamp may indicate the time at which the measurement of the blood pressure was made. In one embodiment, the creation unit 256 may store the first data value, the first resultant value, and the first service value associated with the first proxy device, which represents the first resource constrained device 110-N.

The service unit 258 may generate service values, which correspond to the data values generated by the resource constrained devices 110. In one embodiment, the service unit 258 may generate a service value based on the produce service value signals received form the control unit 252. In one embodiment, the service unit 258 may comprise arithmetic and logic block, clock unit, and such other blocks. In one embodiment, the service unit 258 may generate service values, which may add value to the data values. In one embodiment, the service unit 258 may send the service values to the creation unit 256. For example, the service unit 258 may generate a first service value that represents a time-stamp for the first data value.

In one embodiment, the service unit 258 may generate description of the resource constrained devices 110 based on the service oriented architectures. In one embodiment, the service unit 258, may support service oriented architectures, which may use universal plug and play (UPnP), web services (WS), and such other protocols. The service unit 258 may use the UPnP and WS protocols to enable the access point 130 to seamlessly connect and to simplify the implementation of resource constrained devices 110. In one embodiment, the description may, for example, comprise vendor-specific, manufacturer information like the model name and number, serial number, manufacturer name, URLs to vendor-specific websites and such other details. The description may also include a list of embedded devices or services, as well as URLs for controlling and presentation.

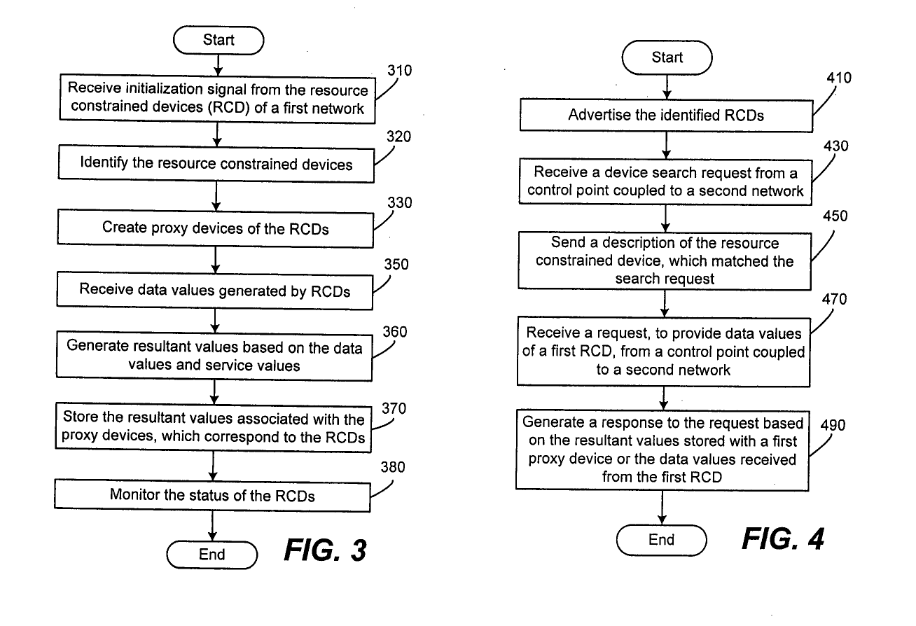

An embodiment of the access point 130 enhancing the representation of the resource constrained devices 110 coupled to a first network is illustrated in FIG. 3.

In block 310, the access point 130 may receive an initialization signal from the resource constrained devices 110 coupled to a first network such as a BlueTooth® network. In one embodiment, the first network may refer to the low-power and low-range network provisioned between the resource constrained devices 110 and the access point 130.

In block 320, the access point 130 may identify the resource constrained devices 110 based on the initialization signals. For example, the access point 130 may identify the resource constrained device 110-N based on the initialization signal sent by the resource constrained device 110-N.

In block 330, the access point 130 may create a proxy device for each of the identified resource constrained devices 110. For example, the access point 130 may create a first proxy device N after identifying the resource constrained device 110-N. In one embodiment, the access point 130 may execute routines written in C, C++ languages to create the first proxy device that may be initiated after identifying the resource constrained device 110-N.

In block 350, the access point 130 may receive data values generated by the resource constrained devices 110. The access point 130 may receive, for example, measurement of blood pressure from the resource constrained device 110-N.

In block 360, the access point 130 may generate resultant values based on the data values such as the first data value and the service values such as the first service value. In one embodiment, the resultant values may comprise a combination of the data values and the service values.

In block 370, the access point 130 may store the resultant values associated with a corresponding proxy device. For example, the access point 130 may store the first resultant value associated with the first proxy device N.

In block 380, the access point 130 may monitor the status of the resource constrained devices such as 110-N.

An embodiment of the access point 130 providing services to the devices coupled to a second network is illustrated in FIG. 4. In block 410, the access point 130 may advertise the identity of the resource constrained device 110-N.

In block 430, the access point 130 may receive a search request from a control point coupled to a second network. In one embodiment, the access point 130 may receive a search request for the first resource constrained device 110-N from the control point 160-B coupled to the network 150.

In block 450, the access point 130 may send a description of the first resource constrained device 110-N based on the device search request sent by the control point 160-B in block 430.

In block 470, the access point 130 may receive a first request to provide data values of the first resource constrained device 110-N and such first request may be sent by the control point 160-B.

In block 490, the access point 130 may generate a first response to the first request based on the first resultant value stored associated with a first proxy device N. In one embodiment, the access point 130 may generate a first response to the first request based on the first data values generated by the first resource constrained device 110-N. Such an approach enables the access point 130 to enhance representation of the resource constrained devices 110 in a broad range network such as the LAN 170 and/or the network 150.

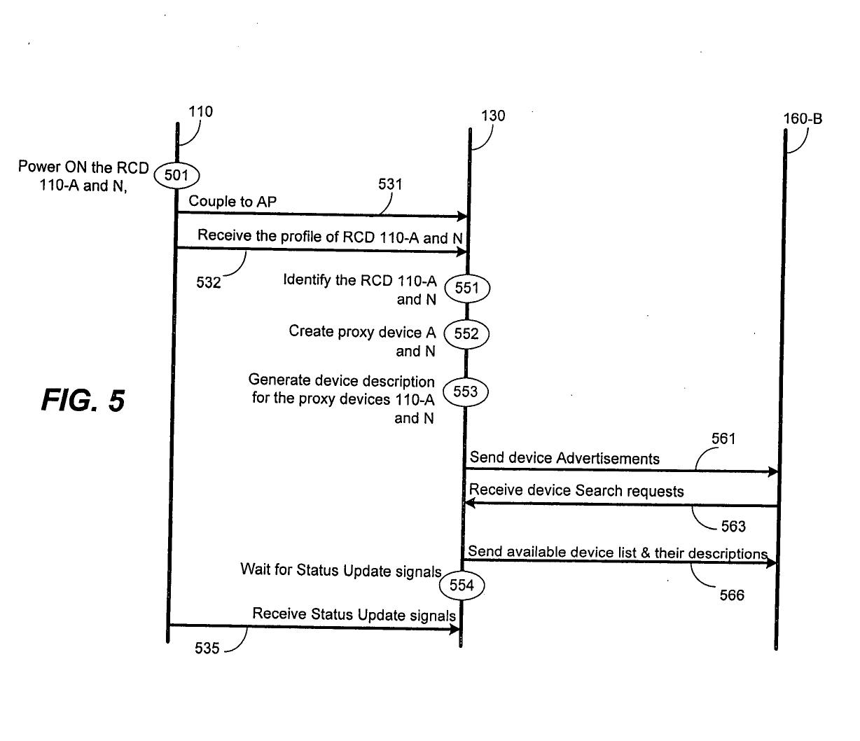

An embodiment of the access point 130 enabling device description and discovery is illustrated in FIG. 5. In one embodiment, the sequence diagram of FIG. 5 indicates the sequence of activities and events that the resource constrained device 110-A and 110-N, the access point 130, and the control point 160-B may perform.

At an event 501, the resource constrained device 110-A and 110-N may be switched ON. As a result, during an activity 531, the resource constrained device 110-A and 110-N may couple to the access point 130 using wireless and/or wired connectivity and low-range protocols such as USB® and ZigBee®. During an activity 532, the access point 130 may receive the initialization signal comprising, for example, a profile of the resource constrained device 110-A and 110-N as noted in block 310 of FIG. 3.

At an event 551, the access point 130 may identify the resource constrained device 110-A and 110-N as noted in block 320 of FIG. 3. At an event 552, the access point 130 may create a first proxy device N and a second proxy device A as noted in block 330 of FIG. 3. At an event 553, the access point 130 may generate a device description for the first resource constrained device 110-N and a second resource constrained device 110-A. The access point 130 may associate the description of the first resource constrained device 110-N and the second resource constrained device 110-A, respectively, with the first proxy device N and the second proxy device A.

During an activity 561, the access point 130 may send an advertisement comprising an identifier of the first and the second resource constrained devices 110-N and 110-A as noted in block 410 of FIG. 4. During an activity 563, the access point 130 may receive a device search request from a control point 160-B coupled to the network 150 as noted in block 430 of FIG. 4. During an activity 566, the access point 130 may send a list of available resource constrained devices and their descriptions. For example, the control point 160-B may send a search request for the devices 110-A, 110-B, and 110-N. However, the access point 130 may respond with a list comprising the identifier of the first and the second device 110-N and 110-A along with the device description as noted in block 450 of FIG. 4.

At an event 554, the access point 130 may wait to receive status updates from the resource constrained devices 110-A and 110-N. During an activity 535, the access point 130 may receive the status update, which may indicate the status of the first and the second resource constrained device 110-N and 110-A as shown in block 380 of FIG. 3.

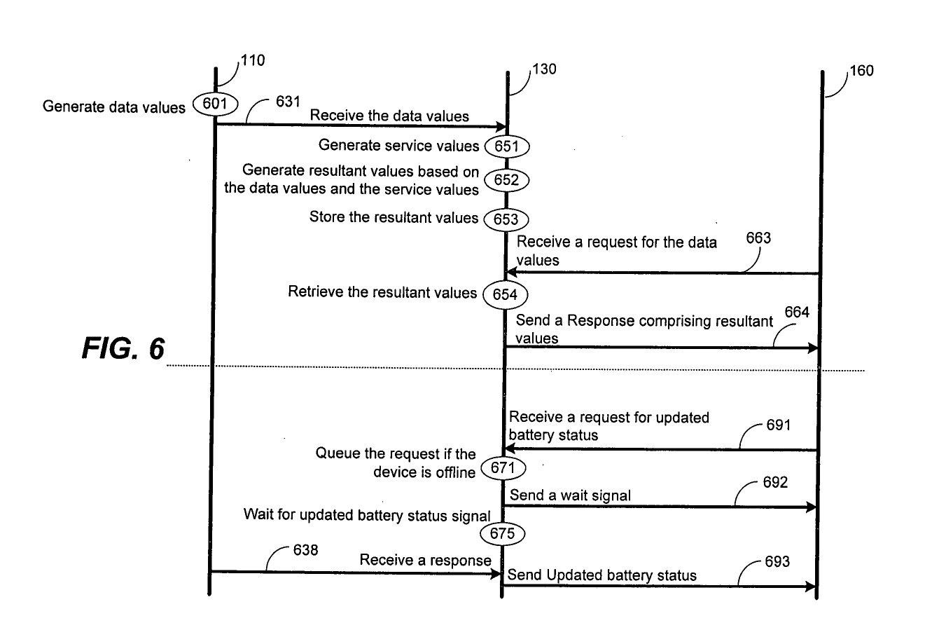

An embodiment of the access point 130 enabling device controlling and eventing is illustrated in FIG. 6. The sequence diagram of FIG. 6 indicates the sequence of activities and events that the resource constrained device 110-A and N, the access point 130, and the control point 160-B may perform. For example, the sequence diagram illustrates an access point 130 providing functionalities such as (1) caching data values; and (2) providing the updated battery status. However, the access point 130 may provide a generic frame work that may enable the proxy devices to provide various functionalities.

While providing the functionality of caching data values, the resource constrained devices 110-A and 110-N, at an event 601, may generate the data values, which may represent the measurement of the physical variables such as the pressure, motion, and vibration. The access point 130, during an activity 631, may receive the data values generated by the resource constrained devices 110-A and 110-N, which is as indicated in the block 350 of FIG. 3. The access point 130, at an event 651, may generate service values based on the services preferred by the control point 160-B. For example, the access point 130 may generate a time-stamp value, which corresponds to the first data value.

The access point 130, at an event 652, may generate the resultant values based on the data values and the service values as indicated in block 360 of FIG. 3. At an event 653, the access point 130 may store the resultant values, for example, associated with the proxy device N as indicated in the block 370 of FIG. 3. During an activity 663, the access point 130 may receive a request from the control point 160-B as indicated in block 470 of FIG. 4. At an event 653, the access point 130 may retrieve the resultant values stored associated with a corresponding proxy device N. At an activity 664, the access point 130 may send the response to the control point 160-B and the response may comprise the resultant values as indicated in block 490 of FIG. 4

While providing the updated battery status functionality, the access point 130, during an activity 691, may receive a request for updated battery status, for example, of the resource constrained device 110-N. At an event 671, the access point 130 may place the request in a queue if the resource constrained device 110-N is in sleep mode or offline and the access point 130 may, during an activity 692, send a wait signal to the requesting control point 160-B. At event 675, the access point 130 may wait to receive the updated battery status form the resource constrained device 110-N. During an activity 638, the access point may receive the updated battery status, which is sent by the resource constrained device 110-N and the access point 130, during an activity 693, may send the updated battery status signal to the control point 160-B.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. An apparatus comprising:
an interface to support communication between a first resource constrained device coupled to a first network and a second device coupled to a second network;
a processor coupled to the interface to create a first proxy device for the first resource constrained device, wherein the first proxy device is to generate a first resultant value for the second device; and
a memory coupled to the processor to store the first resultant value and a first data value.

2. The apparatus of claim 1, wherein the processor is to create the first proxy device in response to receiving an initialization signal from the first resource constrained device.

3. The apparatus of claim 1, wherein the processor is to receive the first data value from the first resource constrained device using a first protocol supported by the first network and to generate the first resultant value using a second protocol supported by the second network.

4. The apparatus of claim 3, wherein the first resultant value comprises a first service value and the first data value, wherein the first service value is a time-stamp for the first data value.

5. The apparatus of claim 3, wherein the first service value is a deviation of the first data value from the average of data values generated by the first resource constrained device.

6. The apparatus of claim 1, wherein the processor is to store the first resultant value during an active mode of operation of the first resource constrained device and to provide the first resultant value to the second device during a sleep mode of operation of the first resource constrained device.

7. The apparatus of claim 1, wherein the processor is to support the first proxy device to represent the first resource constrained device in the second network while the first resource constrained device is in sleep mode.

8. A method comprising:
creating a first proxy device to represent a first resource constrained device having limited resources;
generating a first resultant value based on a first data value generated by the first resource constrained device and a first service value;
storing the first resultant value; and
providing the first resultant value in response to a request sent by a first control point.

9. The method of claim 8 wherein the first proxy device is created in response to receiving an initialization signal from the first resource constrained device.

10. The method of claim 8, wherein the first service value is a time-stamp for the first data value.

11. The method of claim 10, wherein the first service value is a statistical value of data values including the first data value generated by the first resource constrained device.

12. The method of claim 8 further comprising:
storing of the first resultant value while the first resource constrained device is in active mode; and
providing the first resultant value to the control point while the first resource constrained device is in sleep mode.

13. A machine readable medium comprising a plurality of instructions that in response to being executed result in a computing device
creating a first proxy device to represent a first resource constrained device having limited resources,
generating a first resultant value based on a first data value of the first resource constrained device and a first service value,
storing the first resultant value associated with the first proxy device, and
providing the first resultant value in response to a request sent by a first control point.

14. The machine readable medium of claim 13 wherein the first proxy device is created in response to receiving an initialization signal from the first resource constrained device.

15. The machine readable medium of claim 13, wherein the first service value is a time-stamp for the first data value.

16. The machine readable medium of claim 15, wherein the first service value is a statistical value of data values including the first data value generated by the first resource constrained device.

17. The machine readable medium of claim 13 further comprising:
storing of the first resultant value while the first resource constrained device is in active mode; and
providing the first resultant value to the control point while the first resource constrained device is in sleep mode.
